(19) United States
(12) Patent Application Publication
(10) Pub. No.: US 2019/0021292 A1
(43) Pub. Date: Jan. 24, 2019

(54) SYSTEM AND METHOD FOR ADAPTIVE AQUATIC FEEDING BASED ON IMAGE PROCESSING

(71) Applicant: RoboGardens LLC, Flower Mound, TX (US)

(72) Inventor: Stephen Hayes, Flower Mound, TX (US)

(73) Assignee: RoboGardens LLC, Flower Mound, TX (US)

(21) Appl. No.: 15/656,080

(22) Filed: Jul. 21, 2017

(51) Int. Cl. A01K 61/80; A01K 63/06; H04N 7/18; G06T 7/70; G06T 7/20

(52) U.S. Cl. CPC A01K 61/80; A01K 63/06; G06T 2207/30242; G06T 7/70; G06T 7/20; H04N 7/183

(57) ABSTRACT

A system, method and computer program product for feeding aquatic animals, including a hopper configured to hold food to be dispensed; a dispensing mechanism coupled to the hopper to dispense the food from the hopper to a feeding area in water; a camera configured to capture images from the feeding area; and a processor configured to perform image analysis of the images captured from the camera and control the dispensing mechanism based the captured images.

### BACKGROUND OF THE INVENTION

### Field of the Invention

The present invention generally relates to the automatic feeding of fish or other aquatic, and more particularly to a method and system for use of computer vision processing to assess visual characteristics that are markers for how hungry the animals are, and wherein the quantity of food dispensed is adapted to avoid excessive feeding, and the like.

### Discussion of the Background

In aquariums, ponds, or aquaculture operations, it is often desirable to use automatic feeders. Various automatic feeders exist, however; they have drawbacks. The most common automatic feeders simply dispense a predefined amount of food on a fixed schedule (see, e.g., U.S. Pat. Nos. 4,981,106; 6,082,299; 5,873,326; and 2,793,791). More sophisticated automatic feeders depend on mechanical agitation of a probe to trigger dispensing of food (see, e.g., U.S. Pat. Nos. 4,922,856; and 3,741,163). Timed release solutions can either overfeed or underfeed. Beyond the disadvantage of wasting food, overfeeding leads to a buildup of excess food and increases in ammonia that are harmful to the fish. For aquaculture operations and fishing ponds it is desirable to feed the fish as much food as they will eat without wasting food, since this translates into faster growing fish. Mechanical feedback mechanisms are often unreliable since the dispenser can be triggered even when the fish are not hungry. When feeding fish manually, humans use a variety of feedback mechanisms to adjust the amount of food provided. These include the activity of the fish, how many fish are feeding, the time required to consume the food, the amount of food being left over, the temperature of the water. In the past, it has been necessary to choose between the convenience of automatic feeders and the accuracy of manual feeding.

### SUMMARY OF THE INVENTION

Therefore, there is a need for a method and system that addresses the above and other problems. The above and other problems are addressed by the illustrative embodiments of the present invention, which provide an automatic feeder that utilizes visual feedback to adapt the amount of food dispensed. The invention incorporates a camera and a processor running vision processing algorithms to replicate many of the algorithms humans use to avoid over or under feeding. A camera is incorporated into the feeder which has a field of view encompassing the feeding area. Computer vision processing is applied to the images stream in real time as food is being dispensed. Characteristics that can be assessed visually are the activity level of the fish (e.g., feeding frenzy or not), the number of fish in the feeding area, rate at which the food is being consumed and the amount of uneaten food being left. Based on these factors, the automatic feeder can reduce or extend the amount of food dispensed. If food is already present it can skip feeding altogether. Statistics on food consumption can be compiled and alerts can be provided to the operator if food consumption varies from the norm. This can be useful to alert the operator of situations such as sick fish. In addition, by monitoring the rate at which food is dispensed, the feeder can alert the owner that no feed is being dispensed (e.g., such as being out of food).

Accordingly, in illustrative aspects of the present invention there is provided a system, method, and computer program product for feeding aquatic animals, including a hopper configured to hold food to be dispensed; a dispensing mechanism coupled to the hopper to dispense the food from the hopper to a feeding area in water; a camera configured to capture images from the feeding area; and a processor configured to perform image analysis of the images captured from the camera and control the dispensing mechanism based the captured images.

The system, method, and computer program product, further including at least one of lighting for the feeding area; a temperature sensor to determine water temperature in the feeding area; and a range sensor to determine a distance between the dispensing mechanism and the water.

The system, method, and computer program product, further including the processor configured to perform image analysis on the captured images to determine at least one of motion levels within the feeding area, a count of fish within the feeding area, and a quantity of uneaten food in the feeding area, wherein at least one of feeding quantities and duration are adjusted by the processor based the image analysis, and statistics are recorded and maintained based on information provided by the image analysis.

The system, method, and computer program product, further including the processor configured to provide an alarm or alert based on one of if it is determined that no food was dispensed, if behavior during feeding is determined to differ substantially from a baseline amount, if water temperatures exceed a specified limit, and if a water level exceeds a specified limit.

The system, method, and computer program product, further including the processor configured to allow at least one of a user to adjust scheduling and feeding parameters that control dispensing logic using a web based interface a user to retrieve statistics and historical information on past feeding statistics and sensor output, a user to remotely access the camera and view a video feed of the feeding area, and a user to remotely view videos of past feedings.

Still other aspects, features, and advantages of the present invention are readily apparent from the following detailed description, by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 shows an illustrative Adaptive Fish Feeder in which a dispensing mechanism is coupled with a camera, processor, motor and optional lighting, and optional temperature sensor;

FIG. 2 shows an illustrative logic flow for how the Adaptive Fish Feeder adapts the amount of food dispensed based on feedback from the fish and the environment; and

FIG. 3 gives illustrative examples of the types of processing performed on the images and sensor input of the adaptive fish feeder.

### DETAILED DESCRIPTION OF THE PREFERRED EMBODIMENTS

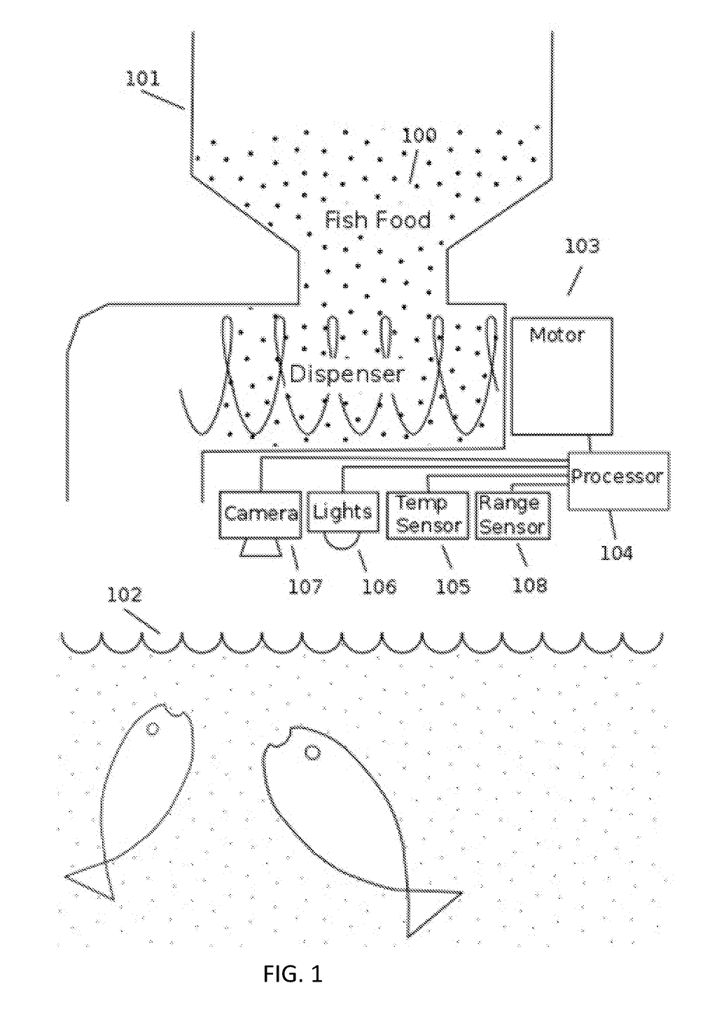

Referring now to the drawings, wherein like reference numerals designate identical or corresponding parts throughout the several views, and more particularly to FIG. 1 thereof, there is shown an illustrative Adaptive Fish Feeder in which a dispensing mechanism is coupled with a camera, processor, motor and optional lighting, optional temperature, and optional range sensors. In FIG. 1, the adaptive Fish Feeder is used to effectively dispense the food 100 contained in the hopper 101 into the water 102. The processor 104 uses the camera 107 to observe the feeding area, and analyzes the collected images to determine the fish activity, uneaten food, lighting conditions, and the like. Advantageously, this allows the processor 104 to establish a baseline for the current feeding conditions, and the like.

If there is insufficient light to reliably assess the feeding conditions, supplemental lighting 106 can be activated. Water temperature information is also collected using the temperature sensor 105. This information is also factored into the feeding algorithms and feeding can be aborted when the water temperature exceeds set limits. The distance between the water level and the camera is determined using the range sensor 108. Advantageously, this allows more accurate determination of the size of the feeding area being observed.

Once the processor 104 has established that feeding should proceed, the motor 103 is activated to dispense a certain quantity of food. During and after dispensing, the processor observes the activity in the feeding area 102. The processor 104 uses any suitable motion detection algorithms, and the like, on the images taken by camera 107 of the feeding area 102 to assess how violently the fish are feeding. The processor 104 employs any suitable image classification algorithms, and the like, on the images taken by camera 107 of the feeding area 102 to determine how many fish are feeding, how much uneaten food remains, and the like.

Based on the results of the image analysis, the processor 104, can perform additional dispensing cycles, or discontinue dispensing. Based on the results of the image analysis, the processor 104, can determine that no food was dispensed and alert the operator using mechanisms, such as email, text, and the like. The processor 104 archives the collected feeding and sensor statistics for trend analysis or viewing by the user. Based on the analyzed data, feeding timing and durations can be adjusted for future feedings, and the like.

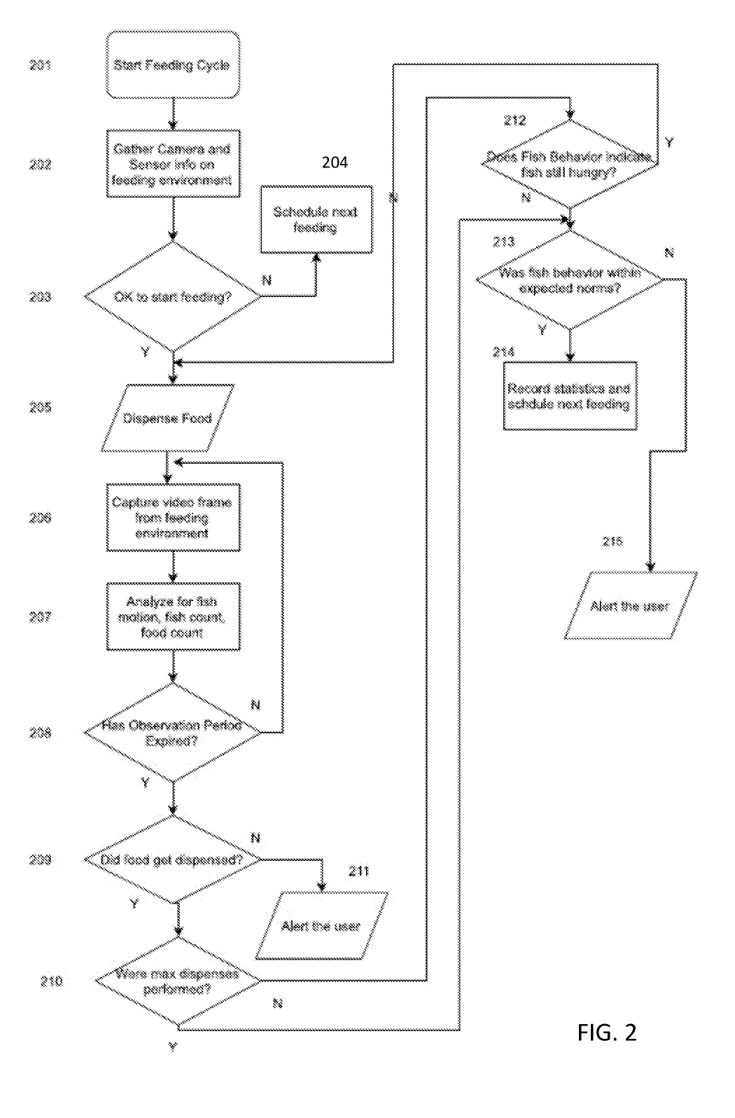

FIG. 2 shows an illustrative logic flow for how the Adaptive Fish Feeder adapts the amount of food dispensed based on feedback from the fish and the environment. In FIG. 2, at step 201, the system initiates a feeding cycle. Feeding can be based on a schedule or can be based on factors such as ambient daylight, level of fish activity, a remote command issued by the user, and the like. In step 202, the system can begin to collect data on the environment. Factors such as whether it is daylight, the water temperature, fish activity, and the like, can be collected. In step 203, the system decides whether to proceed with the feeding cycle. In accordance to parameters set by the user, such as minimum water temperature, only feed during daylight, and the like, the feeding can be aborted. In addition, an operator requested feeding also can be honored.

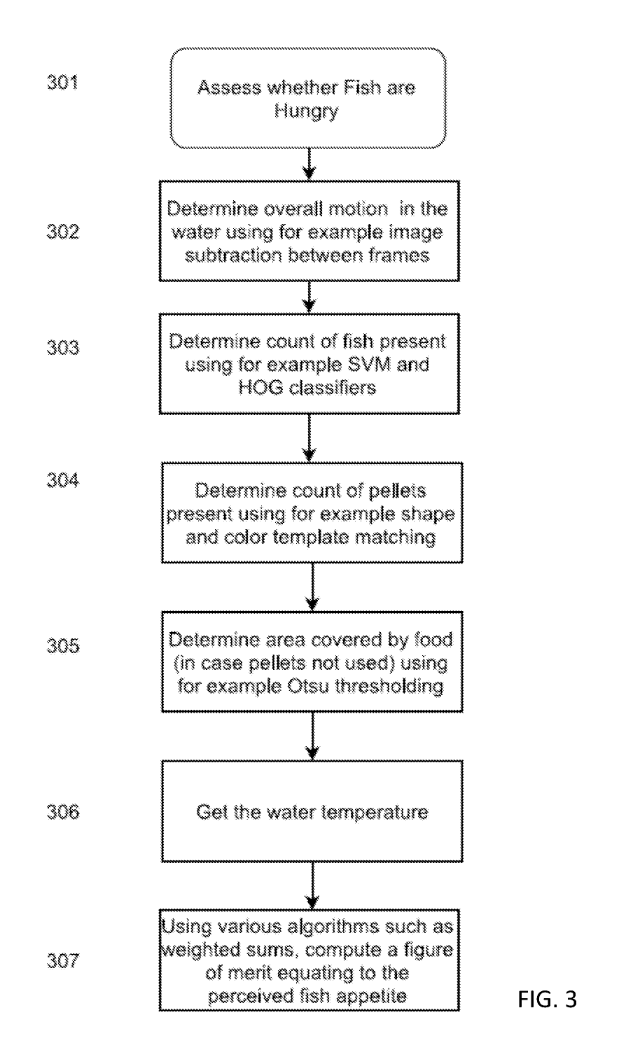

If feeding is aborted, a subsequent feeding is scheduled at step 204. In step 205, the processor can activate the motors to dispense food, wherein a predetermined amount of food is dispensed. In step 206, the system can begin to capture video frames from the camera in real time, near real time, and the like. In step 207, any suitable computer vision processing algorithms, and the like, are applied to the images to extract higher level features, such as activity levels, fish counts, food remaining counts, and the like, for example, as illustrated in FIG. 3.

In step 208, the system checks if the feeding observation period has expired, and if not, more video frames are collected and analyzed. In step 209, the data is analyzed to ensure that food was detected in the water, and if not there can be a jam, empty hopper, and the like, and in which case the user is alerted in step 211. In step 210, a check is performed against the maximum number of dispensing cycles, wherein, for example, this is a check against any software or analysis faults that would otherwise overfeed the fish. If maximum dispenses are reached, then dispensing is terminated and the feeding behavior is compared against expected baselines in step 213.

In step 212, the collected data stream during the feeding is analyzed to determine if the fish exhibit behavior of still being hungry. If still hungry, then an additional food dispensing cycle is performed. In step 213, the feeding data collected is compared against the behavior seen previously in terms of activity, feeding rate, and the like. If the behavior seems anomalous, then the user is alerted in step 215. Assuming behavior was as expected, then the data is recorded and a future feeding is scheduled in step 214.

FIG. 3 gives examples of the processing employed to extract information, such as fish activity, fish counts, uneaten food assessments, and the like, from video frames that are captured during the feeding cycle. In step 301, the processor begins the analysis of a captured image to determine if the fish are eating the food. In step 302, an assessment is made of the amount of motion in the frame. Various approaches can be used, for example, including simple image subtraction from previous frames, and the like. However, suitable clipping, filtering, and the like, can be employed to ensure that it is the fish that are being tracked. In step 303, an assessment is made of fish present in the frame. For example, an approach such as a Histogram of Ordered Gradients (HOG) classifier can be used in conjunction with Support Vector Machine (SVM) learning, and the like.

In step 304, an assessment is made of the amount of uneaten food. For example, approaches such as using Determinant of Hessian filtering can be used since there can be many pellets to count. Motion filters can be applied to distinguish against stationary objects on the bottom of the tank that look like pellets. Ranging information can also be applied since the pellet size can vary depending on the water level. In step 305, additional algorithms are applied to cover items such as flakes or Duckweed that can be fed, but may not be recognized as fish food. In step 306, the water temperature as obtained from a temperature sensor is factored in since it affects fish activity. In step 307, such various factors are evaluated in determining if more food should be dispensed. For example, a scaled weighting of these approaches with cutoffs for various criteria is one such approach.

The above-described devices and subsystems of the illustrative embodiments can include, for example, any suitable servers, workstations, PCs, laptop computers, microcomputers, microcontrollers, PDAs, Internet appliances, handheld devices, cellular telephones, wireless devices, other devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the illustrative embodiments are for illustrative purposes, as many variations of the specific hardware used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance of the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, flash memory, SSD, and the like, of the devices and subsystems of the illustrative embodiments. One or more databases of the devices and subsystems of the illustrative embodiments can store the information used to implement the illustrative embodiments of the present inventions. The databases can be organized using data structures (e.g., records, tables, arrays, fields, graphs, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, and the like, programmed according to the teachings of the illustrative embodiments of the present inventions, as will be appreciated by those skilled in the computer and software arts. Appropriate software can be readily prepared by programmers of ordinary skill based on the teachings of the illustrative embodiments, as will be appreciated by those skilled in the software art. Further, the devices and subsystems of the illustrative embodiments can be implemented on the World Wide Web. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present inventions can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, integrated development environment, and the like. Such computer readable media further can include the computer program product of an embodiment of the present inventions for performing all or a portion (if processing is distributed) of the processing performed in implementing the inventions. Computer code devices of the illustrative embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present inventions can be distributed for better performance, reliability, cost, and the like.

As stated above, the devices and subsystems of the illustrative embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of illustrative embodiments, and implementations, the present inventions are not so limited, but rather cover various modifications, and equivalent arrangements, which fall within the purview of the appended claims.

What is claimed is:

1. A system for feeding aquatic animals, the system comprising:
a hopper configured to hold food to be dispensed;
a dispensing mechanism coupled to the hopper to dispense the food from the hopper to a feeding area in water;
a camera configured to capture images from the feeding area; and
a processor configured to perform image analysis of the images captured from the camera and control the dispensing mechanism based the captured images.

2. The system of claim 1, further comprising at least one of:
lighting for the feeding area;
a temperature sensor to determine water temperature in the feeding area; and
a range sensor to determine a distance between the dispensing mechanism and the water.

3. The system of claim 1, further comprising:
the processor configured to perform image analysis on the captured images to determine at least one of motion levels within the feeding area, a count of fish within the feeding area, and a quantity of uneaten food in the feeding area,
wherein at least one of feeding quantities and duration are adjusted by the processor based the image analysis, and statistics are recorded and maintained based on information provided by the image analysis.

4. The system of claim 1, further comprising:
the processor configured to provide an alarm or alert based on one of:
if it is determined that no food was dispensed,
if behavior during feeding is determined to differ substantially from a baseline amount,
if water temperatures exceed a specified limit, and
if a water level exceeds a specified limit.

5. The system of claim 1, further comprising:
the processor configured to allow at least one of:
a user to adjust scheduling and feeding parameters that control dispensing logic using a web based interface,
a user to retrieve statistics and historical information on past feeding statistics and sensor output,
a user to remotely access the camera and view a video feed of the feeding area, and
a user to remotely view videos of past feedings.

6. A method for feeding aquatic animals, the method comprising:
holding food to be dispensed with a hopper;
dispensing with a dispensing mechanism coupled to the hopper the food from the hopper to a feeding area in water;
capturing with a camera images from the feeding area; and
performing with a processor image analysis of the images captured from the camera and controlling the dispensing mechanism based the captured images.

7. The method of claim 6, further comprising at least one of:
lighting the feeding area;
determining with a temperature sensor water temperature in the feeding area; and
determining with a range sensor a distance between the dispensing mechanism and the water.

8. The method of claim 6, further comprising:
performing with the processor image analysis on the captured images to determine at least one of motion levels within the feeding area, a count of fish within the feeding area, and a quantity of uneaten food in the feeding area,
wherein at least one of feeding quantities and duration are adjusted by the processor based the image analysis, and statistics are recorded and maintained based on information provided by the image analysis.

9. The method of claim 6, further comprising:
providing with the processor an alarm or alert based on one of:
if it is determined that no food was dispensed,
if behavior during feeding is determined to differ substantially from a baseline amount,
if water temperatures exceed a specified limit, and
if a water level exceeds a specified limit.

10. The method of claim 6, further comprising:
allowing with the processor at least one of:
a user to adjust scheduling and feeding parameters that control dispensing logic using a web based interface,
a user to retrieve statistics and historical information on past feeding statistics and sensor output,
a user to remotely access the camera and view a video feed of the feeding area, and
a user to remotely view videos of past feedings.

11. A computer program product for feeding aquatic animals and including one or more computer readable instructions embedded on a tangible, non-transitory computer readable medium and configured to cause one or more computer processors to perform the steps of:
holding food to be dispensed with a hopper;
dispensing with a dispensing mechanism coupled to the hopper the food from the hopper to a feeding area in water;
capturing with a camera images from the feeding area; and
performing with a processor image analysis of the images captured from the camera and controlling the dispensing mechanism based the captured images.

12. The computer program product of claim 11, further comprising at least one of:
lighting the feeding area;
determining with a temperature sensor water temperature in the feeding area; and
determining with a range sensor a distance between the dispensing mechanism and the water.

13. The computer program product of claim 11, further comprising:
performing with the processor image analysis on the captured images to determine at least one of motion levels within the feeding area, a count of fish within the feeding area, and a quantity of uneaten food in the feeding area,
wherein at least one of feeding quantities and duration are adjusted by the processor based the image analysis, and statistics are recorded and maintained based on information provided by the image analysis.

14. The computer program product of claim 11, further comprising:
providing with the processor an alarm or alert based on one of:
if it is determined that no food was dispensed,
if behavior during feeding is determined to differ substantially from a baseline amount,
if water temperatures exceed a specified limit, and
if a water level exceeds a specified limit.

15. The computer program product of claim 11, further comprising:
allowing with the processor at least one of:
a user to adjust scheduling and feeding parameters that control dispensing logic using a web based interface,
a user to retrieve statistics and historical information on past feeding statistics and sensor output,
a user to remotely access the camera and view a video feed of the feeding area, and
a user to remotely view videos of past feedings.
